(19) United States
(12) Patent Application Publication
(10) Pub. No.: US 2026/0274694 A1
(43) Pub. Date: Sep. 17, 2026

(54) METHODS, SYSTEMS, AND APPARATUSES FOR IN-SITU PRODUCTION OF COMPOUNDS VIA SUBSURFACE GEOTHERMAL CHEMICAL REACTIONS

(71) Applicant: MASSACHUSETTS INSTITUTE OF TECHNOLOGY, Cambridge, MA (US)

(72) Inventors: Iwnetim ABATE, JR., Chestnut Hill, MA (US); Yifan GAO, Cambridge, MA (US); Ju LI, Weston, MA (US)

(21) Appl. No.: 19/669,673

(22) Filed: May 6, 2026

Related U.S. Application Data
(63) Continuation of application No. PCT/US2024/055583, filed on Nov. 12, 2024.
(60) Provisional application No. 63/547,898, filed on Nov. 9, 2023.
(60) Provisional application No. 63/644,489, filed on May 8, 2024.

(51) Int. Cl. C01C 1/02; B01J 27/122; B01J 27/128; C01C 1/04; C01C 1/16; C01C 1/26; E21B 43/295

(52) U.S. Cl. CPC C01C 1/026; B01J 27/122; B01J 27/128; C01C 1/0405; C01C 1/164; C01C 1/26; E21B 43/295

(57) ABSTRACT

Systems and methods for in situ production of ammonia and/or ammonium salt compounds using subsurface geochemistry are provided. In some embodiments, one or more reactants can be transported to a subsurface region of the earth for the purpose of forming ammonia and/or ammonium salts in-situ. The reactants can contact a rock bed of ultramafic rocks to react to form hydrogen gas (H₂). The hydrogen gas can then be reacted with a nitrogen source to form ammonia that can be collected. In alternate embodiments, the nitrogen gas can be pumped into contact with the hydrogen gas released from the rock bed to form ammonium salt in the earth's crust, which can be excavated. In some other embodiments, a catalyst can be transported along with reactants, or a reaction can be facilitated by a catalyst in the rock bed, to form ammonia gas in situ without hydrogen gas formation.

### CROSS REFERENCE TO RELATED APPLICATION

The present disclosure claims priority to and the benefit of U.S. Provisional Application No. 63/547,898, entitled “Methods, Systems, and Apparatuses for In-Situ Production of Ammonia and Ammonium Salts from Nitrogen Via Subsurface Geothermal Chemical Reactions,” filed on Nov. 9, 2023, and U.S. Provisional Application No. 63/644,489, entitled “Methods, Systems, and Apparatuses for In-Situ Production of Geological Ammonia Via Subsurface Geothermal Chemical Reactions,” filed on May 8, 2024, the content of which is incorporated by reference herein in its entirety.

### FIELD

The present disclosure relates to in-situ production of geological ammonia and/or ammonium salt(s), and more particularly relates to methods and apparatuses for leveraging subsurface geochemical reactions to provide optimal conditions for ammonia and/or ammonium salt formation using catalysts.

### BACKGROUND

In recent years, use of ammonia (NH₃) as an energy source has greatly increased as an alternative to fossil fuels. Additionally, ammonia has begun to be used as fertilizers and fuels to power various plants and machinery. For example, ammonia production from dinitrogen (N₂), or nitrogen gas, and dihydrogen (H₂), or hydrogen gas, via the Haber-Bosch process accounts for production of 150 million tons per year. Current ammonia production techniques have several shortcomings. First, ammonia production is very energy intensive. For example, the Haber-Bosch process requires high pressure (from about 200 atm to about 400 atm) and high temperature (from about 400° C. to about 650° C.), and indirectly generates millions of tons of CO₂ based on consumption of natural gas and other fossil fuels as an energy source. Second, practice of the Haber-Bosch process is very expensive as the sourcing of hydrogen gas, which is a reactant in the process, accounts for more than 30% of the cost of the overall production of the ammonia and/or ammonium salts. Still further, facilities that perform the Haber-Bosch process tend to have wide footprints, with large numbers of storage tanks, reactors, and/or other facilities to facilitate the reaction and manage the resulting output of ammonia and/or ammonium salts.

Accordingly, there is a need for alternative methods and systems of ammonia production that would allow for scalability and widespread adoption while minimizing energy use.

### SUMMARY

The present application is directed to methods, systems, and apparatuses for producing ammonia and/or ammonium salt(s). For example, the instantly disclosed methods, systems, and apparatuses produce ammonia (NH₃) by splitting the N≡N bond in an aqueous reaction that uses heat and iron (Fe)-rich ultramafic material(s) (e.g., rocks) including but not limited to peridotites, olivines ((Mg, Fe)₂SiO₄), pyroxenes ((Mg,Fe)CaSi₂O₆), and/or fayalite (Fe₂SiO₄) at the subsurface of the earth. By performing the reaction at elevated temperatures and pressures afforded by the subsurface of the earth, the instantly disclosed methods, systems, and apparatuses produce and collect ample product without excessive expenditures of energy seen in the Haber-Bosch process. The in-situ production of NH₃ and/or ammonium salt(s) can use a reactor extending into a vertical hole in the earth and having an outer flow passage receiving influent fluid (H₂O and N₂) from a supply and supply lines pumped by a pressure pump. The fluid can undergo an accelerated reaction with ultramafic rock beds under the hole, for example with iron oxide (FeO)-containing rocks giving off NH₃, which flows up an inner flow passage to a settling or collection tank and/or other discharge lines. In some embodiments, the system can provide for control of flow rate, pH, and rock surface depassivation to maximize reaction rates and yield. A catalyst can be added in conjunction with the influent fluid via the vertical hole or extracted from the rock bed in the reaction zone to facilitate ammonia production without first forming an intermediate hydrogen product, thereby reducing energy consumption and decreasing the temperature and pressure requirements of the reaction zone to facilitate the reaction.

One method of producing at least one of ammonia or ammonium salt via geochemistry includes transporting an aqueous solution and a nitrogen source below a surface of the earth to facilitate a reaction to form at least one of ammonia or ammonium salt.

The method can further include reacting the aqueous solution with the ultramafic rock to produce hydrogen gas (H₂). The hydrogen gas can be collected in a reservoir. In some embodiments, the hydrogen gas can be reacted with the nitrogen source using geothermal energy to form the at least one of ammonia or the ammonium salt. The ammonium salt can be collected from the ultramafic rock, wherein the ammonium salt can include one or more of Salammoniac (NH₄Cl) and ammonium bicarbonate (NH₄HCO₃). One or more secondary reactants can be transported below the surface of the earth to facilitate formation of the ammonium salt.

The aqueous solution can be transported to a rock bed that includes ultramafic rock that is disposed below the surface of the earth. The nitrogen source can include one or more of N₂, NO, N₂O, NO₂, NOₓ, or NO₃. The hydrogen gas can react with the nitrogen source at a pressure approximately in a range of about 1 atm to about 400 atm. The hydrogen gas can react with the nitrogen gas in a reaction vessel. The reaction can occur from about one foot below the surface of the earth to about five miles below the surface of the earth. The ammonia can be collected in a collection tank.

In some embodiments, transporting the aqueous solution and the nitrogen source through the surface of the earth can include passing the aqueous solution and the nitrogen source through a plurality of boreholes disposed in the surface of the earth. Transporting can include pumping or co-injecting the aqueous solution and the nitrogen source through a plurality of boreholes below the surface of the earth.

The aqueous solution and the nitrogen source can flow through a single borehole of a plurality of boreholes disposed in the surface of the earth. In some embodiments, the reaction can occur in a presence of one or more catalysts to produce ammonia. The ammonia can be produced without forming hydrogen gas (H₂). The one or more catalysts can be transported to below the surface of the earth to increase one or more of the yield or rate of ammonia production. In some embodiments, the one or more catalysts can be transported through the single borehole of the plurality of boreholes. The one or more catalysts can include one or more of nickel, copper, cobalt, sodium, magnesium, calcium, titanium, chromium, iron, zinc, platinum, ruthenium, osmium, aluminum oxide, calcium oxide, molybdenum, ruthenium, alloys of different metals, or organic and metalorganic catalysts. In some embodiments, the one or more catalysts can be naturally occurring below the surface of the earth.

In some embodiments, a droplet of the aqueous solution can be created prior to transporting the aqueous solution below the surface of the earth, with the droplets being created using an electrospray apparatus attached to the plurality of boreholes. Using a controller, at least one of a flow rate of one or more of the aqueous solution or the nitrogen source transported below the surface of the earth or a composition of one or more of the aqueous solution or the nitrogen source can be adjusted.

A conversion rate of ammonia from iron below the surface of the earth can be in approximately a range from about 5% to about 80%. A yield of the ammonia can range from about 10 g NH₃/t olivine to about 500 g NH₃/t olivine. The ammonia can be withdrawn from below the surface of the earth and collected in a collection tank.

One method of increasing a yield of ammonia production includes exposing an aqueous solution and a nitrogen source below a surface of the earth to an iron-containing rock bed in a presence of a catalyst to facilitate a reaction to form ammonia.

The catalyst can be transported below the surface of the earth. The reaction can form ammonia without forming hydrogen gas (H₂). The catalyst can be naturally occurring below the surface of the earth. In some embodiments, the catalyst can be naturally occurring within the iron-containing rock bed. The one or more catalysts can include nickel, copper, cobalt, sodium, magnesium, calcium, titanium, chromium, iron, zinc, platinum, ruthenium, osmium, aluminum oxide, calcium oxide, molybdenum, ruthenium, alloys of different metals, or organic and metalorganic catalysts. The reaction can occur at a temperature approximately in a range from about room temperature to about 500° C. In some embodiments, the reaction can occur at a temperature approximately in a range from about room temperature to about 300° C. The reaction can occur at a pressure approximately in a range from about 1 atm (0.1 MPa) to about greater than 30 MPa.

One embodiment of a system for producing at least one of ammonia or ammonium salt via geochemistry includes one or more flow passages extending from a surface of the earth and an apparatus in fluid communication with the rock bed via the one or more flow passages. The apparatus is configured to deliver an aqueous solution and a nitrogen source proximate to a rock bed disposed below the surface of the earth to react with the rock bed to form a product.

The product can be at least one of ammonium salt or hydrogen gas. The system can include a reservoir configured to collect the product. The reservoir can be disposed below the surface of the earth. In some embodiments, the system can include a controller in communication with at least one of the one or more flow passages or the apparatus that is configured to adjust at least one of a flow rate of one or more of the aqueous solution or the nitrogen source transported below the surface of the earth or a composition of one or more of the aqueous solution or the nitrogen source.

In some embodiments, the system can include a reaction tank in fluid communication with the one or more flow passages and is configured to facilitate a reaction between the product and the nitrogen source to form a gas. The reaction tank can be disposed below the surface of the earth.

The system can include a collection well in fluid communication with the reaction tank and configured to collect the gas. In some embodiments, the gas can include ammonia.

### BRIEF DESCRIPTION OF THE DRAWINGS

This disclosure will be more fully understood from the following detailed description, taken in conjunction with the accompanying drawings, in which:

FIG. 1 is a schematic representation of an example embodiment of a system and method for subsurface geothermal production of ammonia in which water reacts with a rock bed to form hydrogen gas, which then reacts with nitrogen injected to a subsurface to form ammonia in a subsurface reaction tank;

FIG. 2A is a schematic representation of an example embodiment of a system and method for subsurface geothermal production of ammonia in which water reacts with a rock bed in the presence of a catalyst to form ammonia that is collected in an above ground collection tank;

FIG. 2B is a schematic, pictorial representation of the system of FIG. 2A;

FIG. 3A is a schematic magnified representation of the reaction zone of the method for subsurface geothermal production of ammonia of FIG. 2A in which nitrogen gas reacts with water in the presence of a catalyst;

FIG. 3B is a schematic magnified representation of the reaction zone of the method for subsurface geothermal production of ammonia of FIG. 2A in which nitrate reacts with water in the presence of a catalyst;

FIG. 4A is graph illustrating gas chromatography of hydrogen gas generation during a reaction between synthetic mineral (Fe(OH)₂) of rock and fluid;

FIG. 4B is a nuclear magnetic resonance (NMR) spectrum of ammonium generation from a synthetic mineral of Iron (II) hydroxide (Fe(OH)₂) of rock and fluid;

FIG. 4C is a graph illustrating hydrogen gas generation from actual-mineral rock using a nickel catalyst;

FIG. 4D is an NMR spectrum of ammonium generation from olivine;

FIG. 4E is an NMR spectrum of ammonium generation from a synthetic mineral of Iron (II) hydroxide (Fe(OH)₂) of rock using a copper catalyst;

FIG. 4F is an NMR spectrum showing isotopic measurement of ammonium formation using nitrate sources;

FIG. 5A is a graph illustrating x-ray diffraction (XRD) of a synthetic rock in its Fe(OH) 2 state before a reaction;

FIG. 5B is a graph illustrating XRD of the synthetic rock of FIG. 5A synthetic rock after its transformation to Fe₃O₄ after the reaction;

FIG. 5C is a graph illustrating X-ray photoemission spectroscopy (XPS) of the synthetic rock of FIG. 5A before the reaction;

FIG. 5D is a graph illustrating X-ray photoemission spectroscopy (XPS) of the synthetic rock of FIG. 5A after its transformation to Fe₃O₄ after the reaction;

FIG. 6A is a schematic illustration of a molecular structure of HNO₃* generated from a reaction of NO₃* and a nearest surface hydroxide ion (OH⁻);

FIG. 6B is a schematic illustration of a molecular structure of HNO₃* generated from a reaction of NO₃* and a second nearest surface hydroxide ion (OH);

FIG. 6C is a schematic illustration of a molecular structure generated from an adsorbed water (H₂O) reaction with an adsorbed NO₃*, producing HNO₃* and OH*;

FIG. 6D is a free energy diagram of ammonia generation on a Fe(OH)₂ and nickel-doped Fe(OH)₂ surface where the hydrogen in the ammonia is from the water molecule of FIG. 6C;

FIG. 6E is a graph illustrating a comparative analysis of various catalysts on an amount of geoammonia produced; and

FIG. 7 is a schematic representation of an example embodiment of a system and method for subsurface geothermal production of ammonium salt(s) in which water reacts with a rock bed to form hydrogen gas, which then reacts with nitrogen injected to a subsurface and a secondary reactant to form ammonium salt(s).

### DETAILED DESCRIPTION

Certain exemplary embodiments will now be described to provide an overall understanding of the principles of the systems and methods disclosed herein. The description is inclusive of all descriptions, including any accompanying figures, whether in the present document and/or any materials or other information incorporated by reference herein. One or more examples of these embodiments are illustrated in the accompanying drawings. Those skilled in the art will understand that the systems, methods, and apparatuses specifically described herein and illustrated in the accompanying drawings are non-limiting exemplary embodiments and that the scope of the present disclosure is defined solely by the claims. The features illustrated or described in connection with one embodiment may be combined with the features of other embodiments. Such modifications and variations are intended to be included within the scope of the present disclosure. To the extent the present disclosure includes illustrations and descriptions that include schematic illustrations of systems, apparatuses, set-ups, techniques, methodologies, and the like, a person skilled in the art will recognize how to reply upon the present disclosure to integrate the systems, apparatuses, set-ups, techniques, methodologies, and the like into a product, system, production, method, etc. of effecting in-situ production of ammonia. Additionally, to the extent the present disclosure includes various terms for components and/or processes of the disclosed systems, apparatuses, set-ups, techniques, methodologies, and the like, one skilled in the art, in view of the claims, present disclosure, and knowledge of the skilled person, will understand such terms are merely examples of such components and/or processes, and other components, designs, processes, and/or actions are possible.

At least one novel feature of the present embodiments includes use of geothermal chemistry for ammonia and/or ammonium salt production. For example, one or more reactants can be transported to a subsurface region of the earth, e.g., at or otherwise within the earth's crust, for the purpose of forming ammonia and/or ammonium salts in-situ. The reactants can include, for example, water (H₂O) and nitrogen (N₂), with the water being transported to come into contact with a rock bed of ultramafic rocks to react to form hydrogen gas (H₂). The hydrogen gas can then be captured in a subsurface vessel only permeable to H₂ and reacted therein with nitrogen to form ammonia that can be transported to the surface. In alternate embodiments, the nitrogen gas can be pumped into contact with the hydrogen gas released from the rock bed to form ammonium salt in the earth's crust. The ammonium salt can then be excavated, for example as per traditional mining and/or fracking techniques. Alternatively, a catalyst can be transported along with reactants, or a reaction can be facilitated by a catalyst in the rock bed, to form ammonia gas in situ. Formation of ammonia and/or ammonium salts via the methods, systems, and apparatuses disclosed herein can leverage the increased temperature and pressure in the earth's crust (which turns out to be the temperature and pressure need for the Haber-Bosch reaction but now provided by the subsurface at certain depth) to provide the energy needed for the reactions to occur.

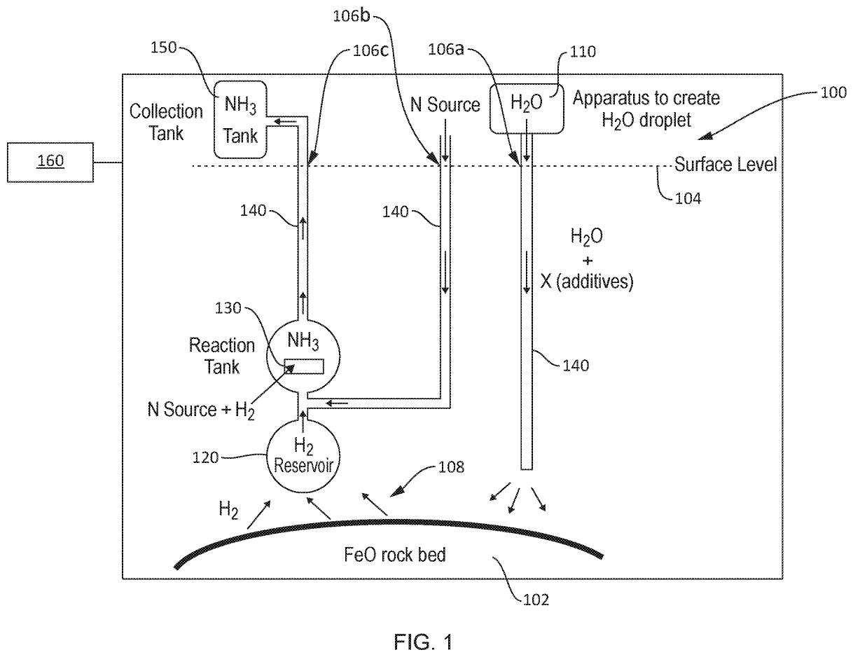

FIG. 1 illustrates one example embodiment of a system 100 for geothermal production of ammonia of the present embodiments. Geothermal production of ammonia can include a reaction that causes subsurface production of hydrogen gas from an influent fluid or an aqueous solution, e.g., water. Such a reaction can take place on the surface of iron-rich ultramafic rocks (referred to as FeO rock bed or rock bed 102 because the iron is Fe II valence state). In the reaction, the rock bed 102 can be oxidized while the water can be reduced to form hydrogen gas. The iron inside the rock can be in Fe II valence state, e.g., ferrous oxide (FeO), with the iron functioning as a catalyst, to form the FeO rock bed 102. When water contacts the ultramafic rock bed (the FeO rock bed 102), the Fe gets oxidized to Fe-IV while reducing water (H₂O) to gas (H₂). The location in which this reaction takes place is referred to as the reaction zone 108 for the purposes of this disclosure, which, in some embodiments, can have a pressure approximately in a range of about 1 atm to about 400 atm.

The system 100 used for subsurface geothermal production of ammonia can include a number of components in various combinations. For example, the system 100 can include one or more of a fluid delivery apparatus 110, a reservoir tank 120, a reactor or reaction tank 130, a plurality of flow passages 140 to transport reactants and/or products between the surface and the earth's crust, and/or a collection tank 150. As shown, various portions of the system 100 can be strategically connected to be in fluidic communication with each other, such as the reservoir 120, the reaction tank 130, the collection tank 150, and/or a component (not shown) that aids in providing nitrogen through one or more flow passages 140 that can outlet to a region between the reservoir 120 and the reaction tank 130. A person skilled in the art, in view of the present disclosure, will appreciate other fluidic communications that can be utilized in alternative embodiments. One or more pumps (not shown) can be used in conjunction with these components to transport the compounds and/or adjust flow rates of the compounds traveling back and forth. It will be appreciated that the system 100 can be modular such that various components can be added and/or removed based on the desired reaction product.

As shown, water can be transported below the surface of the earth or the subsurface 104 through one or more boreholes 106 via the plurality of flow passages 140. Each of the flow passages 140 can connect to one or more components of the system 100, such as the apparatus 110, the collection tank 150, and so forth. Compounds can flow in either direction through the flow passages 140, with some compounds flowing to the subsurface 104 to react with the rock bed 102, and product can flow back above the surface for collection. It will be appreciated that the flow passages 140 can include tubes, pipes, and/or other similar structures used to transport fluid. The flow passages can be made from one or more materials know to one skilled in the art, such as stainless steels, carbon steels, nickel alloys, titanium alloys, ceramic, copper, polyvinyl chloride, aluminum and so forth.

The system 100 can include a controller 160 for adjusting one or more system parameters. For example, one or more of the flow rate and/or the composition of the influent fluid can be adjusted. In some embodiments, a flow rate of the water through the borehole 106a can be adjusted to be approximately in a range of about 5 cubic meters per second to about 50 cubic meters per second, and more particularly approximately in a range of about 20 cubic meters per second to about 30 cubic meters per second.

The fluid delivery apparatus 110 can be and/or resemble a water tank, a hose, stainless steel borehole pipes, or the like. As noted above, water can be transported using one or more pumps, injection devices, and/or flow devices and/or be gravity fed through the flow passages 140. In some embodiments, the water can include one or more additives that can catalyze subsurface reactions and/or promote free-flow of the water through the borehole. The additives can include chemical additives or catalysts that can: 1) control the pH to enhance the rate and yield of the reaction with the olivine rock; and/or 2) provide chemicals that depassivate ultramafic rocks after the reaction so that the surface of the rock can be available for several cycles of hydrogen gas production. A person skilled in the art will recognize that depassivation of the ultramafic rocks is used due to the surface of the rock being covered with a Fe₃O₄ passivation layer, which can prevent further reaction. Chemicals can be added to the surface to prevent formation of the passivation layer, which can make the surface available for several reaction cycles. Some non-limiting examples of the additives can include some acids and fluorine containing chemicals. In some embodiments, the additives can be used to control pH.

In use, the fluid delivery apparatus 110 can be configured to create, pump, co-inject, and/or deliver a mixture of water and the additives through the boreholes 106 via the flow passages 140. The water can be delivered in the form of individual water droplets to increase the rate of evaporation in the reaction zone. In some embodiments, the droplets can be created using an electrospray apparatus attached to a down-going flow passage. In some embodiments, the liquid water injected to the subsurface 104 can vaporize in the flow passage 140 from the high-temperature without using electrospray.

The flow passages 140 can extend under the earth's surface 104, e.g., within the earth's crust, to a depth at which the ultramafic rock 102 is found. For example, ultramafic-rich regions of the earth's crust can be detected by remote sensing, seismic survey, borehole and well logging, geochemical analysis, and the like as known to one skilled in the art, and as such a detailed discussion of detection is omitted from this disclosure. While the depth of the location within the earth's crust that ultramafic is found can depend on factors including but not limited to geography, climate, and so forth, a depth of the boreholes 106a, 106b used in the present disclosure can be approximately in a range of about 1 foot to about 10 miles below the earth's surface, approximately in a range of about 1 foot to about 5 miles below the earth's surface, approximately in a range of about 3 feet to about 10 miles below the earth's surface, approximately in a range of about 3 feet to about 10 miles below the earth's surface, approximately in a range of about 5 feet to about 10 miles below the earth's surface, and/or approximately in a range of about 5 miles to about 5 miles below the earth's surface.

Once the mixture is injected into, and/or otherwise contacts, the FeO rock bed 102, a reaction can occur to release hydrogen gas. For example, in some embodiments, FeO in the ultramafic rock can be oxidized while the water from the influent fluid is reduced to produce H₂: 2FeO(s)+H₂O_{(l/g)}→Fe₃O₄₍ₛ₎+H_{2(g)} (which is a generic and simplified reaction that explains what is going in the ultramafic rock). The water can be a liquid or a gas, depending on the reaction set-up (e.g., injecting liquid water and/or droplets in vapor form). The specific reaction may depend on the type of ultramafic rock. The following are two examples of specific reactions: 6 Fe₂SiO₄₍ₛ₎ [fayalite]+7 H₂O_{(l/g)}→3Fe₃Si₂O₅(OH)₄₍ₛ₎ [lizardite]+Fe₃O₄₍ₛ₎ [magnetite]+H_{2(g)}. The released hydrogen gas can be captured in the reservoir 120 located below the surface. As shown, the reservoir 120 can be positioned near the rock bed 102 and proximate to the reaction zone 108 to maximize the amount of gas collected and help manage the combustibility of hydrogen gas, and thus maximize the amount of efficiency and safety. The reservoir 120 can be and/or resemble a flask having a porous membrane to allow hydrogen gas to pass through the porous membrane (not shown) and into the reservoir 120. The porous membrane can be configured to keep the hydrogen gas trapped in the reservoir 120 for, as shown, subsequent transport for interaction in the reaction tank 130. In some embodiments, the membrane can be configured to selectively allow hydrogen gas to permeate therethrough to maximize the amount and/or purity of hydrogen gas trapped in the reservoir.

The hydrogen gas from the reservoir 120 can mix with the nitrogen gas that is transported underneath the surface. For example, nitrogen gas can be transported through a second borehole 106b via the flow passage 140 towards the reservoir 120 to allow for mixing with the hydrogen gas. Mixing can occur at the outlet of the reservoir 120, though in some embodiments, a separate tank can be used for the reaction, as shown. For example, the reservoir 120 can be in fluid communication with the reaction tank 130 that is configured to facilitate the reaction of the hydrogen gas with the nitrogen gas to form ammonia (NH₃). An example reaction is as follows: N₂ (g)+3H₂ (g)→2NH₃(g).

In some embodiments, the reaction tank 130 can be coated with a catalyst to promote reaction between the reactants. Some non-limiting examples of the catalyst can include iron and ruthenium. The catalyst can differ from a catalyst used to facilitate the reaction to form ammonia as discussed below, though it will be appreciated that in some embodiments, the catalyst can be the same.

The location of the reaction tank 130 can depend, at least in part, on a temperature and/or pressure that is found at that depth to promote optimal reaction conditions. For example, formation of ammonia can leverage the increased temperature and pressure in the earth's crust to provide the energy needed for the reaction to occur. Therefore, in some embodiments, the reaction tank 130 can be disposed at a depth in the earth's crust such that a surrounding pressure can be approximately 200 atm or more, or, in some embodiments, approximately in a range of about 200 atm to about 400 atm, approximately in a range of about 1 atm to about 400 atm, or approximately in a range from about 1 MPa to about 30 MPa. The reaction tank 130 can be disposed at a depth in the earth's crust such that a surrounding temperature can be approximately 90° C. or more, or, in some embodiments, approximately in a range of about 90° C. to about 400° C., or approximately in a range of about 250° C. to about 600° C. At this depth, the reaction can occur smoothly while avoiding the release of carbon dioxide and other harmful gasses that are part of the Haber-Bosch process discussed above. Temperatures and pressures as discussed herein can be found at depths approximately in a range of about 1 mile below the earth's surface to about 5 miles below the earth's surface, and/or approximately in a range of about 3 miles below the earth's surface to about 5 miles below the earth's surface depending on the location in the world.

The reaction tank 130 can be in fluid communication with the collection tank 150 for receiving the ammonia therein. As shown, once the ammonia is formed, the ammonia can flow from the reaction tank 130 to the collection tank 150 for storage and/or shipping via the flow passage 140 through borehole 106c. While the collection tank 150 is shown being above the surface of the earth 104, in some embodiments, a subsurface collection tank can be used in lieu of and/or in addition to the collection tank 150. It will be appreciated that a distance between the reaction tank 130 and the collection tank 150 can be greater than a distance between the rock bed 102 and the reservoir 120, and the reservoir 120 and the reaction tank 130, due to the increased stability of ammonia gas as compared to hydrogen gas during transport. In some embodiments, in lieu of, or in addition to, having one or more collection tanks 150, the resulting ammonia can be pumped or otherwise transported to a location for subsequent use without the ammonia first sitting in a collection tank(s). Such a location may be near the location of the system 100, and/or such a location may be located remote from the location of the system 100, for example, the ammonia can be transported through a network of pipes or flow passages 140 to a remote location.

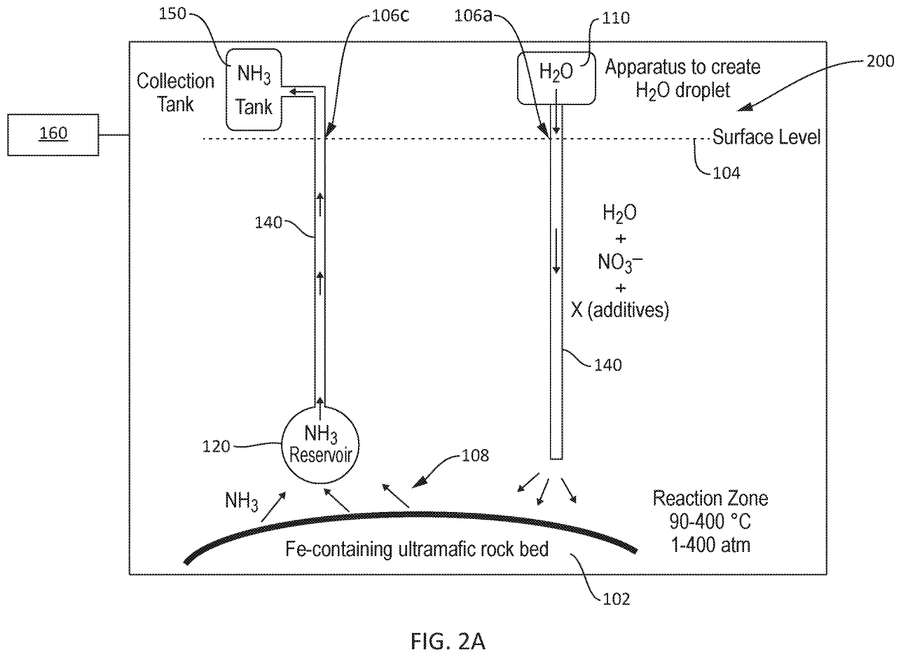

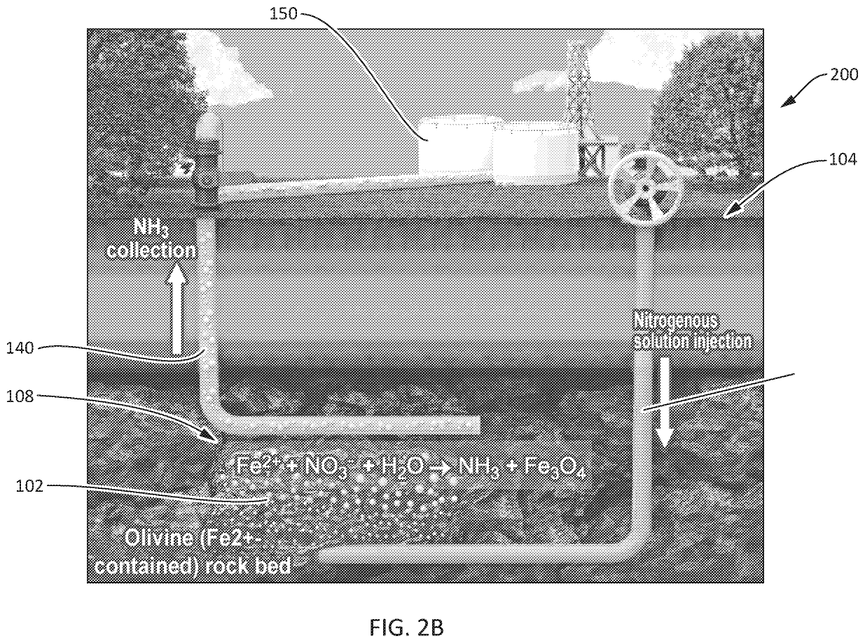

FIGS. 2A-2B illustrate one example embodiment of a system 200 for geothermal production of ammonia of the present embodiments in which the ammonia is produced without first forming hydrogen gas. To the extent that certain features of ammonium gas production is the same or similar to that of the system 100 discussed above, a detailed analysis thereof is omitted for the sake of brevity.

Production of ammonia in the system 200 can occur at scale with nominal zero-CO₂ emissions, no mineral supply chain constraints, while aiming for competitive costs compared to Haber-Bosch. To date, “natural hydrogen” or “geological hydrogen” has emerged as an alternative pathway to alleviate the challenges associated with the electrochemical production of hydrogen. Natural hydrogen can be produced by chemical redox reaction known as serpentinization, where Fe-containing rocks (ultramafic rocks) can be oxidized while reducing underground water to H₂, in which the subsurface can provide the necessary heat and pressure for this thermochemical reaction (approximately in the range of about 90° C. to about 270° C. and up to approximately in the range of about 20 MPa to about 35 MPa. During low-temperature serpentinization reaction (e.g., approximately in the range of about 90° C. to about 200° C.), ultramafic rocks such as olivine ((Fe,Mg)₂SiO₄) can undergo a series of chemical transformations when exposed to water. First, the reaction can lead to the release of dissolved ions such as Mg²⁺ and Fe²⁺. Further, Fe²⁺ can undergo a transformation to form Fe(OH)₂. Additionally, hydrogen gas (H₂) can be generated during the oxidation of Fe²⁺ within Fe(OH)₂ to form Fe₃O₄ (magnetite).

The pathway of hydrogen production from rocks, called a serpentinization process, can be currently explained mainly by the following reaction processes (Eq. 1-4):

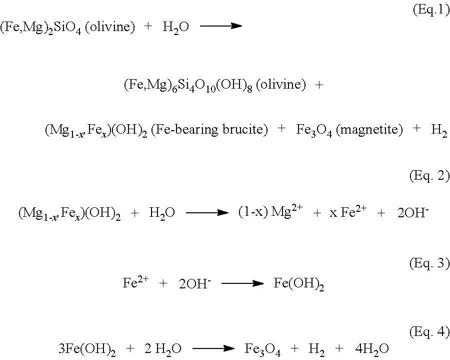

In principle, the production of hydrogen can rely on the redox reaction between the ferrous iron (Fe²⁺) and water. Inspired by this, the reduction potential of ferrous iron in rocks can be utilized, but instead of reducing water, nitrogenous substances (nitrate or nitrogen gas) can be reduced in the expectation of producing ammonia. The following reaction equation (Eq. 5) describes the chemistry basis of geological ammonia production: Nitrate in aqueous solution is reduced by Fe(OH)₂ present in (or transformed from) the rock to generate ammonia, while Fe(OH)₂ can be oxidized to Fe₃O₄, a relevant part of which is also shown in FIG. 2B:

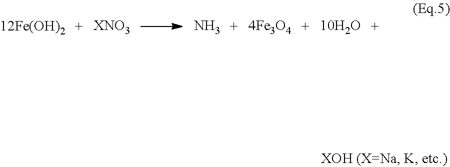

At least one novel feature of the present embodiments can include the addition of a catalyst to the geothermal reaction. For example, the system 200 can expose the ultramafic rock bed 102 to water and a nitrogen source (NO₃⁻ and N₂) in the presence of a catalyst (Cu²⁺ or Ni²⁺) to synthesize ammonia. Some additional non-limiting examples of the nitrogen source can be nitrogen gas (N₂), nitrous oxide (N₂O), nitric oxide (NO), NOₓ, and/or nitrogen dioxide (NO₂), and some additional non-limiting examples of catalysts can include nickel, copper, cobalt, sodium, magnesium, calcium, titanium, chromium, iron, zinc, platinum, ruthenium, and osmium, aluminum oxide, calcium oxide, molybdenum, ruthenium, alloys of different metals, organic and metalorganic catalysts, and so forth. The catalyst can be co-injected with the water and/or nitrogen source via the apparatus 110, though in some embodiments, the rock bed 102 can include one or more of the catalysts therein to help with facilitating the reaction. It will be appreciated that the catalyst need not be expensive nor difficult to obtain, which can further add to the scalability and the ease of use of the present methods. Determination of the presence of the catalyst in the rock bed 102 can be performed by methods known to one skilled in the art, such as rock sampling, aeration, magnetic imaging, and so forth.

As shown, an aqueous solution containing the nitrogen source, in addition to water and/or an additive, e.g., a catalyst, as in the system 100, can be pumped or co-injected into the ground to react with ferrous-containing rocks, producing a solution containing ammonia that will be collected back above ground. The nitrogen source and the water can be co-injected through the apparatus 110 via the passages 140 disposed in the bore hole 106a into the ground to react with the rock formed therein. To manage the flow of compounds effectively, additional equipment such as pumps may be incorporated. The process initiates with the conveyance of water, nitrogen sources (either N₂ or NO³⁻), and various additives—such as catalysts and pH adjusting agents—towards an ultramafic rock bed via the first borehole 106a to facilitate the redox reaction upon the rock's surface. Following this reaction, ammonia (NH₃) can be produced and then exits the subsurface 104 through the flow passage 106c via the borehole 106c, where it is subsequently collected at the surface. Collection can occur in the collection tank 150 or in another vessel known to one skilled in the art. In some embodiments, the system 200 can include an injection well (not shown) that includes the apparatus 110 into the subsurface 104, and a production well (not shown) for collecting the ammonia gas. In some embodiments, pumps may be employed to regulate compound flow.

In the above-described system 200, no reaction tank 130 is needed, though it will be appreciated that one or more of these components can be used if desired. Rather than separately injecting nitrogen gas through the subsurface 104 to react with the hydrogen gas formed as a result of the reaction with the rock bed 102 as in the system 100, the system 200 exposes the rock bed 102 to the nitrogen source, thereby leveraging compounds in the earth to make the ammonia gas. As shown, the reservoir 120 in this system 200 can be positioned near the rock bed 102 and proximate to the reaction zone 108 to maximize the amount of ammonia gas collected, rather than hydrogen gas, and help manage the combustibility of ammonia gas, and thus maximize the amount of efficiency and safety. Similar to the system 100 above, the reservoir 120 can be and/or resemble a flask having a porous membrane to allow ammonia gas to pass through the porous membrane (not shown) and into the reservoir 120. The porous membrane can be configured to keep the ammonia gas trapped in the reservoir 120 for, as shown, subsequent transport for interaction in the collection tank 150. In some embodiments, the membrane can be configured to selectively allow ammonia gas to permeate therethrough to maximize the amount and/or purity of the ammonia gas trapped in the reservoir 120.

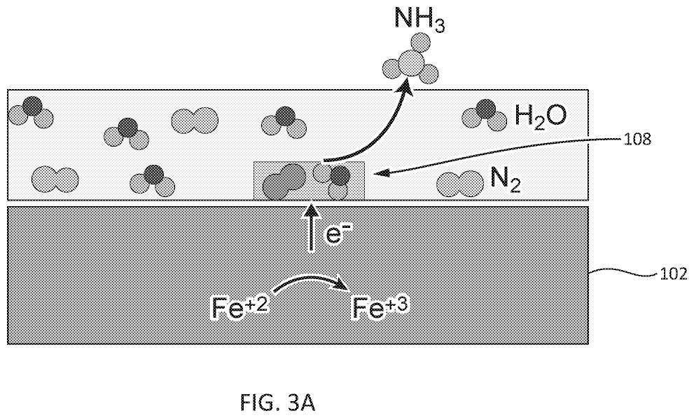

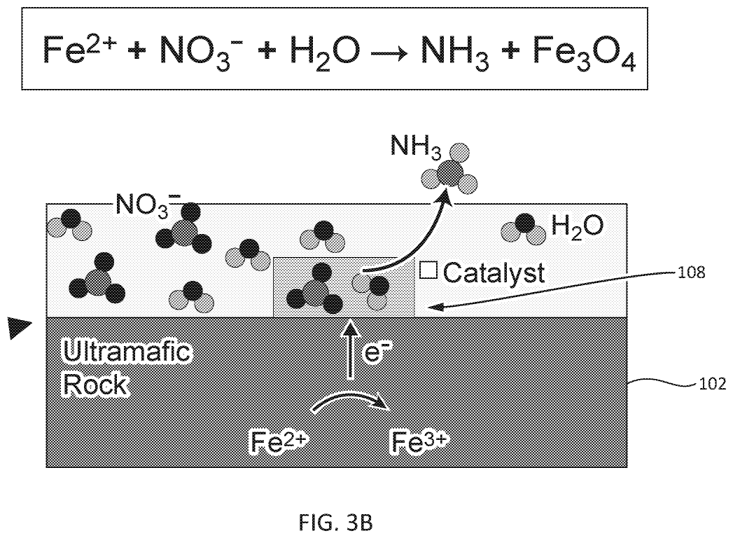

FIG. 3A illustrates the reaction at the rock-fluid interface in greater detail, with the Fe in the rock being oxidized while reducing (N₂+H₂O) into NH₃. Simultaneously, this oxidative process can result in the reduction of the nitrogen sources and water (NO₃⁻/N₂+H₂O) into ammonia (NH₃). This intricate reaction can showcase the transformation of nitrogen sources into a valuable ammonia product through a controlled and efficient process, leveraging the natural properties of ultramafic rocks and the strategic configuration of the system's components. Compared to the Haber-Bosch process, this subsurface ammonia production method can offer potential advantages, including no additional hydrogen, no heating and high pressure, in-situ utilization of geological heat and pressure potential, and zero, or substantially zero, CO₂ emissions. This method's decentralized nature can also offer a more scalable and sustainable approach to ammonia production that leverages the temperature and pressure that occurs in the reaction zone 108 below the surface level 104 of the earth. FIG. 3B illustrates a reaction at the rock-fluid interface in greater detail, with the Fe in the rock being oxidized while reducing (NO₃⁻+H₂O) into NH₃, as shown in the accompanying reaction.

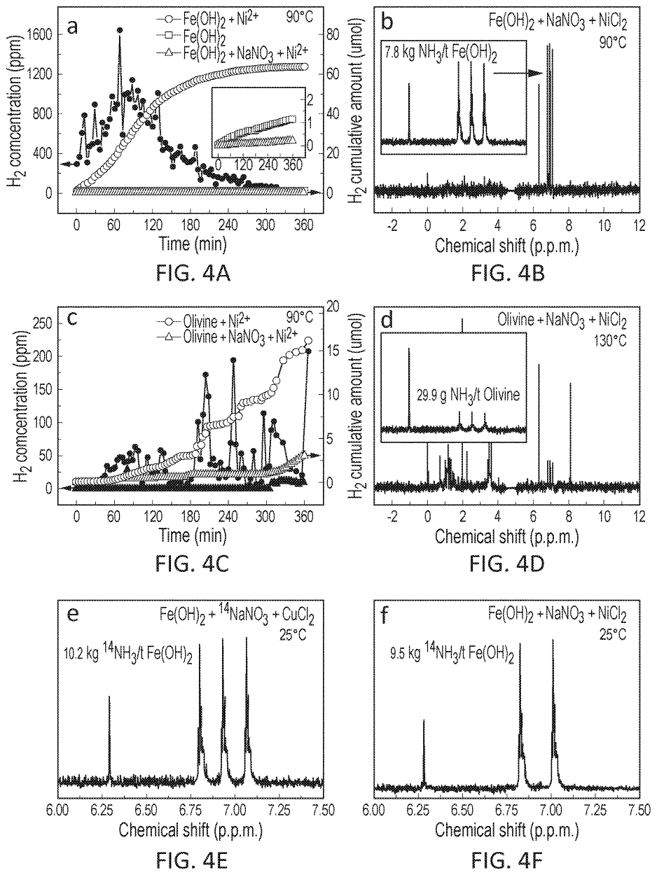

FIGS. 4A-4F illustrate ammonia and hydrogen gas production capabilities under controlled conditions. To enhance the rate and yield of hydrogen production, Ni2⁺ can be introduced as a catalyst into the Fe(OH)₂ matrix equivalent to 1% of the Fe(OH)₂ mass, which can significantly accelerate hydrogen gas production. As shown in FIG. 4A and its magnified inset, the initial reaction of Fe(OH)₂ with water at 90° C. and atmospheric pressure can yield trace amounts of hydrogen gas, detectable through Gas Chromatography (GC) analysis. The catalyst can be one or more transition metals that are added to the reaction via the bore hole as an additive and/or be naturally occurring in the rock bed. For example, addition of a small amount of Ni²⁺ as a catalyst into the Fe(OH)₂ matrix can accelerate hydrogen gas production and enhance the rate and yield of hydrogen gas production by 50 times. Adding sodium nitrate to the mixture decreased hydrogen production to nearly zero but increased production of geological ammonia, thereby proving that ammonia can be produced from representative rock-like chemical substances, further confirmed by distinct spectral lines of NH₄⁺ in its associated nuclear magnetic resonance (NMR) spectra, as shown in FIG. 4B.

FIGS. 4C-4F illustrate additional features of hydrogen and ammonia generation in the presence of catalysts, with both the rate and yield of production of ammonia increasing significantly in the presence of a catalyst. For example, in some embodiments, about 7.8 kg NH₃ per tonne of Fe²⁺ can be produced, translating to a conversion rate of 49.2% according to the principal chemical equation (Eq. 5). The conversion rate of ammonia from iron below the surface of the earth can be in approximately a range of about 5% to about 80%, with the values ranging based on a variety of differences, such as rock types in different regions. In some embodiments, the yield of the ammonia can range from about 10 g NH₃/t olivine to about 500 g NH₃/t olivine. Moreover, hydrogen can be produced from actual rocks, e.g., olivine, at a rate of about 3.23 μmol g⁻¹ h⁻¹, which is nearly 100 times higher than conventionally reported rates, with rates of up to 300 times being possible.

The introduction of nitrate into this system can result in the detection of NH₄⁺ in the NMR spectra, as shown in FIG. 4D, thereby demonstrating that each tonne of olivine can produce about 29.9 g of NH₃. Replacing the catalyst from Ni²⁺ to Cu²⁺ can further increase the yield of NH₃ to about 63.3 g NH₃/tonne olivine, showing that as a simulated rock Fe(OH)₂ can produce large amounts of NH₃ in just about 10 minutes at room temperature (25° C.) and about 1 atm, as shown in FIG. 4E. This conversion can occur at a temperature that is approximately in a range from about room temperature to above about 300° C., e.g., about 300° C., about 400°, about 500° C., or more. A range of pressure can be approximately in a range from about 1 atm (0.1 MPa) to greater than about 30 MPa. When no catalyst was added, the amount of NH₃ produced by the reaction between the olivine and the nitrate solution can be about 15.8 g NH3/t olivine.

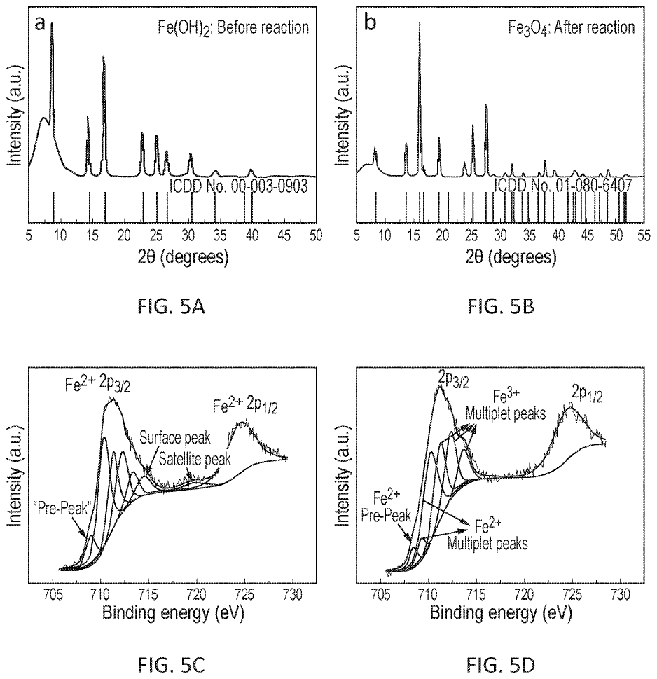

As mentioned earlier, the Geological Ammonia can be produced by a novel “modified serpentinization” reaction by oxidation of Fe (i.e., in Fe²⁺) in rocks (both olivine and synthetic) to Fe³⁺ (to form Fe₃O₄). FIGS. 5A-5D illustrate the chemical and structural transformation of the rock during the reaction. For example, FIG. 5A illustrates that the synthetic rock can be present in Fe(OH)₂ phase (without any notable impurity peaks) with Fe in its +2 oxidation as examined by x-ray diffraction (XRD). After the reaction of NH₃ generation, Fe²⁺ in the synthetic rock can get oxidized to Fe³⁺ and can form Fe₃O₄, XRD results of the synthetic rock (see FIG. 5B) can show its transformation from Fe(OH)₂ (before reaction) to Fe₃O₄ (after reaction) with some of the Fe getting oxidized to +3 oxidation state. To re-confirm the same and to accurately probe into the oxidation state of the Fe in synthetic rock before and after the reaction, X-ray photoelectron spectroscopy can been conducted before and after the reaction, as shown in FIGS. 5C and 5D, respectively. In support of XRD results, XPS can also show the oxidation of Fe (from Fe²⁺ before reaction; see FIG. 5C) can occur during the serpentinization reaction to +3 oxidation (to form Fe₃O₄ after reaction; see FIG. 5D).

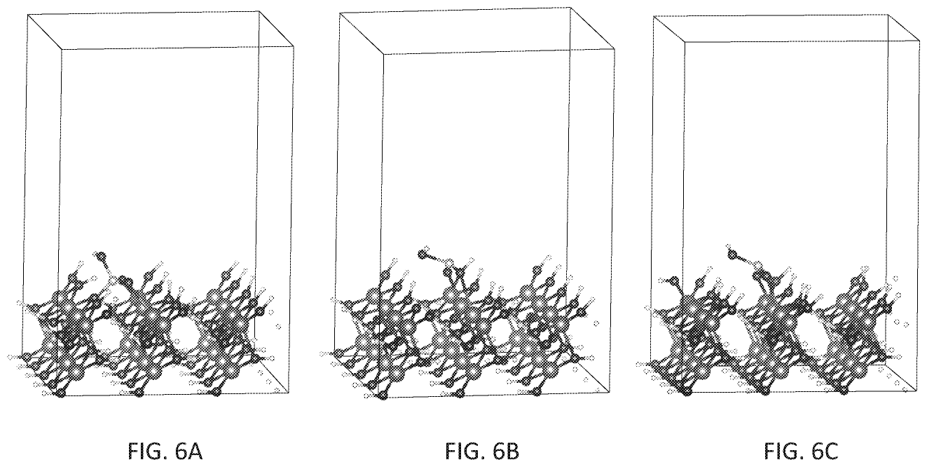

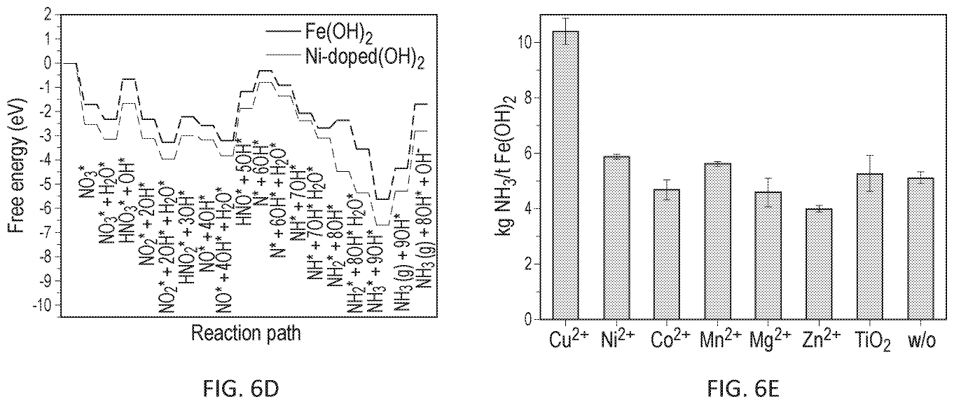

Furthermore, the reaction (Eq. 5) mechanism can be investigated by density functional theory (DFT) calculations. For the reaction in Eq. 5, the hydrogen sources in NH₃ can come from either H₂O or Fe(OH)₂. First, we consider Fe(OH)₂ as the hydrogen source. When a NO3- ion adsorbs on the surface, it reacts with surface OH— to generate HNO₃*, as shown in FIGS. 6A-6B below. In FIG. 6A, the structure of HNO₃* generated from NO₃* and the nearest surface OH— (indicated by the arrow) can have a ΔG of 1.77 eV. This structure is HNO₄*, a stable tetrahedron unit, making it unfavorable for subsequent reactions. In FIG. 6B, the structure of HNO₃* formed with the second nearest surface OH— (indicated by the arrow) has a ΔG of 2.62 eV, which is too high. When considering the hydrogen originating from H₂O, the adsorbed H₂O can react with the adsorbed NO₃*, producing HNO₃* and OH*, as depicted in FIG. 6C. This reaction has a ΔG of 1.66 eV, making it energetically more favorable than the previous two scenarios (with energy difference of ~40KbT and ~4KbT than FIGS. 6A and 6B, respectively). Based on these observations, the hydrogen in the ammonia gas product (NH₃) comes from H₂O rather than Fe(OH)₂. Therefore, in the following calculations, we will consider H₂O as the hydrogen source for NH₃ (as shown in Eq. 6):

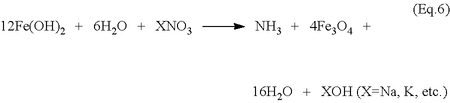

That is, at least one unexpected feature of the reaction mechanism for ammonia formation of the present embodiments is in fact a one-step process rather than a two-step process. Specifically, the hydrogen atom that combines with the N₂ to form the ammonia gas comes from the water co-injected through the subsurface 104, rather than forming hydrogen gas that then reacts with the N₂ to form the NH₃. In fact, hydrogen gas is not formed as an intermediate product due to the nitrogen source directly reacting with H⁺ or OH⁻ in water through redox reactions. Therefore, because hydrogen gas is not formed in an intermittent reaction, presence of the nitrogen source changes the reaction mechanism from a conventional two-step process to a one-step process. This change can allow for more efficient ammonia production as well as reduced demand for high pressures and temperatures to create the ammonia, as in Haber-Bosch, instead allowing the reaction to occur at the temperatures and pressures discussed above. This can allow for lower kinetic barriers and for digging to lower depths, which can reduce costs of the machinery and piping used to facilitate delivery of the compounds to the reaction zone 108.

FIG. 6D shows the calculated free energy changes of the ammonia generation on Fe(OH)₂ and Ni-doped Fe(OH)₂ (100) surface where the H in NH₃ is from water. Ni-doped Fe(OH)₂ can exhibit stronger adsorption energy for NO₃⁻ (−2.54 eV on Ni-doped Fe(OH)₂ and −1.69 eV on Fe(OH)₂), which can be beneficial for the subsequent reactions. Moreover, the overall free energy changes on Ni-doped Fe(OH)₂ can be more negative, indicating a thermodynamically more favorable process. In addition, the effect of different additives on the amount of geo-NH₃ produced is shown in FIG. 6E. As shown, copper ion (Cu²⁺), nickel ion (Ni²⁺), and/or manganese (Mn²⁺) can all favor Geo-NH₃ production, with copper ion being the most effective. Cobalt (Co²⁺), TiO₂ suspended particles, and/or magnesium (Mg²⁺) ions can have little effect on ammonia production, while zinc ion (Zn²⁺), on the contrary, can reduce ammonia production compared to when zinc is absent. This result can help provide guidance for the addition of catalysts to aqueous solutions pumped underground to further enhance the rate of geo-NH₃ production.

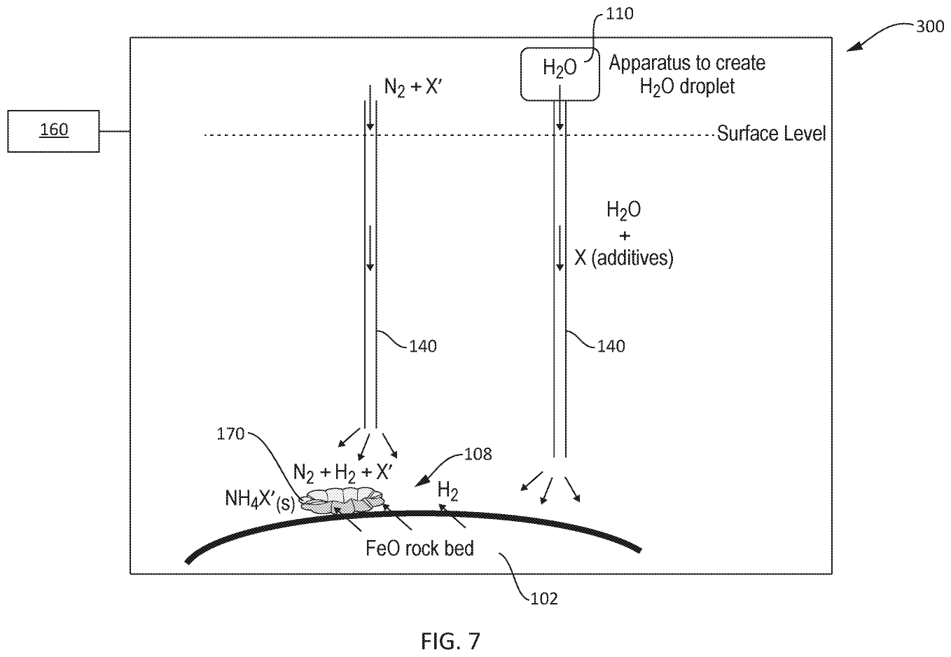

FIG. 7 illustrates one example embodiment of a system 300 for geothermal production of ammonium salts 170 of the present embodiments. To the extent that certain features of ammonium salt production is the same or similar to that of the production of ammonia discussed above, a detailed analysis thereof is omitted for the sake of brevity.

As shown, water, or a mixture of water and additives, can be pumped or co-injected from an apparatus 110 to the rock bed 102 to react to form hydrogen gas, just as in the above. Rather than collecting the hydrogen gas product, however, nitrogen gas and a secondary reactant (X′) can be separately transported toward the rock bed 102 via the flow passage 140, as shown. When the hydrogen gas reacts with the nitrogen gas and the secondary reactant (X′), a solid ammonium salt 170, e.g., NH₄⁺ (s), can be formed, which can precipitate under the earth's surface 104 in stable form. An example reaction is as follows: aN₂ (g)+bH₂ (g)+c X′ (l/g)→dNH₄ X′ (s) (where a, b, c and d are reaction-balancing coefficients and X′ can be in liquid or gas phase). Some non-limiting examples of the secondary reactant (X′) can include hydrochloric acid (HCl), carbonic acid (H₂CO₃), and/or carbon dioxide gas (CO₂), among others. The ammonium salt product 170 can include Salammoniac, ammonium chloride, aluminum bicarbonate, ammonium sulfide, ammonium sulfate, and/or ammonium phosphate, among others.

In the above-described system 300, no reservoir 120, reaction tank 130, or collection tank 150 is needed, though it will be appreciated that one or more of these components can be used if desired. The ammonium salt 170 can then be mined, excavated, extracted, and/or collected by techniques known to those skilled in the art, such as known mining techniques.

In an alternate embodiment of the present disclosure, hydrogen gas can be transported through the flow passages 140 instead of water. For example, in such embodiments, rather than transporting water to react with the rock bed 102 to form hydrogen gas, hydrogen gas, and, optionally, one or more additives, can be transported to the reaction zone. Nitrogen gas, and, optionally, the secondary reactant (X′), can also be transported to the reaction zone 108 to react with the hydrogen gas to form ammonia and/or ammonium salts. The iron inside the ultramafic rock can be a catalyst for this reaction (similar to the Fe catalyst used in Haber-Bosch process but here may be provided naturally by the surface of the rock where the reaction takes place). In such embodiments, the pressure and temperature of the earth's crust can be used to provide optimal conditions for the formation of ammonia and/or ammonium salts without the heavy environmental consequences and the capital costs of the Haber-Bosch process.

### Experimental Procedures

### Materials

Olivine was purchased from Ward's Science. Chemicals including sodium nitrate (99.995% trace metals basis), sodium nitrate-¹⁵N (≥98 atom % ¹⁵N), iron (II) chloride (99.99% trace metals basis), copper (II) chloride (97%), nickel (II) chloride hexahydrate (99.999% trace metals basis), sodium hydroxide (anhydrous, ACS reagent), Sulfuric acid (99.999%), maleic acid (standard for quantitative NMR), deuterium oxide (≥99.95 atom % D) were purchased from Sigma-Aldrich without further purification. Deoxygenated deionized water was flushed with argon for about 30 minutes to remove dissolved oxygen and stored in a glove box that was oxygen-free (O₂ concentration<about 0.5 ppm) but allowed aqueous solution, referred as water glove box for short in the following.

Geological NH₃ or H₂ Production Experimental Setup

A rock-water reaction system can include an autoclave reactor integrated with a gas system and a heating system. The autoclave reactor can be equipped with a gas inlet and a gas outlet, where both inlet and outlet pipelines are fitted with gas mass flow controllers to control and record the gas flow. The gas inlet can be connected to an argon gas cylinder to supply argon as a carrier gas. Additionally, the gas outlet can be linked to a gas chromatograph (GC) for real-time in-situ measurement of the gas composition and concentration inside the autoclave. The heating system can be capable of controlling and measuring the internal temperature of the autoclave reactor. A temperature probe can be inserted tunnel-like into the interior of the autoclave. Based on the temperature feedback from the temperature probe and the set target temperature, the heating base can adjust to regulate the temperature.

For actual mineral reaction experiments, olivine minerals can be processed through crushing with a hammer, coarse grinding, and fine grinding until powdered samples were obtained for subsequent experiments. Within an argon gas-filled water glove box, a certain amount of olivine powder, deoxygenated deionized water, NaNO₃ solution, NaOH solution, and a solution of CuCl₂ or NiCl₂ as a catalyst can be sequentially added into the autoclave and then sealed. For simulated mineral reaction experiments, a certain amount of FeCl₂ solution, NaOH solution, a solution of CuCl₂ or NiCl₂ as a catalyst, and NaNO₃, can be sequentially introduced into the autoclave and sealed. In this case, the first added chemicals FeCl₂ and NaOH can in situ produce Fe(OH)₂ precipitate, which can be used as a simulated mineral. The autoclave can then be placed within the heating system and connected to the gas pipeline system, after which the temperature and operation duration can be set to start the experiment. For Geo-H₂ experiments, NaNO₃ was not added for purposes of the described experiments. Instead, an equivalent volume of deionized water was used to ensure the overall reaction volume, and the concentrations of other reactants remain unchanged. For rapid tube tests at room temperature, neither the high-pressure autoclave reactor nor the heating system was used. Rather, the simulated rock-water reaction was simply completed within a test tube. These rapid tube tests were performed for optimization and mechanism investigation, so reaction was set for about 10 minutes to improve efficiency, while for the actual olivine mineral, the reaction lasted for about 21 hours to explore NH₃-producing capacity. The isotopic experiment was conducted by using 15N—NaNO₃ instead of 14N—NaNO₃ as a reactant in similar experimental conditions.

### Characterizations

Solid samples after experiments were obtained by separating solid and liquid through a vacuum filtration system set up in the water glove box. Powder X-ray diffraction (Panalytical Empyrean, Mo K-α radiation, λ=0.7107 Å) was used to determine the crystal structure of the model compounds and minerals before and after the reaction. X-ray photoelectron spectroscopy (XPS; PHI VersaProbe II X-ray Photoelectron Spectrometer) was performed, using monochromated Al K-alpha (X-radiation pass energy=2.95 eV) as the excitation source, to look into the oxidation states of the Fe close to the surface of the particles. In all the characterization techniques used above, to capture the accurate data before and after the reaction, samples were protected while doing all the characterizations by using air-free holders.

NH₃ and H₂ Production Rate Measurements and Calculations

The NH₃ concentration in solution was measured directly via nuclear magnetic resonance (NMR). All tests were repeated at least three times. A certain amount of maleic acid (MA) was added as an internal standard as well as a certain amount of H₂SO₄ to adjust the pH to the solution after filtration. ¹H NMR spectra were obtained using a three-channel Bruker Avance Neo spectrometer operating at about 400.17 MHz. A standard curve is established based on the internal MA and external NH₄Cl standards. For all the NMR results, NH₃ concentration based was quantitatively calculated on the standard chemical (MA as internal standard). The NH₃ yield (g NH₃/t olivine or g NH₃/kgFe²⁺) can be converted from the solution NH₃ concentration and the mass of rock added at the beginning of the reaction. NH₃ production ratio was obtained by dividing the actual NH₃ production by the theoretical maximum by production when oxidizing all Fe²⁺ in the rock to Fe₃O₄.

The composition and concentration of the gas in the autoclave were analyzed in-situ by a GC (MG #5, SRI) equipped with a high-sensitivity thermal conductivity detector (TCD) detector directly connected to the outlet of the autoclave. A standard curve is established based on the external H₂ standards and the H₂ concentration in the gas can be calculated. The H₂ yield (μmol g⁻¹ h⁻¹) can be converted from the outlet gas H₂ concentration, total volume of the autoclave system, and the mass of rock added at the beginning of the reaction. The H₂ production ratio was obtained by dividing the actual H₂ production by the theoretical maximum by production when oxidizing all Fe²⁺ in the rock to Fe₃O₄.

### DFT Calculation Method

Spin-polarized DFT calculations were carried out using the Vienna ab initio simulation package (VASP5.4.4). The Generalized Gradient Approximation (GGA) of Perdew, Burke and Ernzerhof (PBE) was used to model electron exchange-correlation interactions, employing a plane waves cutoff of 400 eV. Grimme's DFT+D3 method was employed to account for the van der Waals interactions. The Hubbard U correction (DFT+U) was incorporated to accurately describe the correlation energy for the 3d orbitals of Fe and Ni atoms, using effective parameters U-J of 5.67 and 5.23 eV for Fe and Ni respectively, as referenced from Song et al. The convergence criteria for energy and force were set at 10⁻⁵ eV and 0.03 eV·Å⁻¹, respectively. A 2×2×1 Monkhorst-Pack grid was used to sample the electron's Brillouin zone.

A 4×3 supercell was constructed with two layers of the (100) surface of Fe(OH)₂. For the Ni-doped Fe(OH)₂ scenario, one surface Fe atom was replaced with Ni. During structural relaxation, the bottom layer remained fixed, while the top layer was allowed to relax. The H₂O adsorption energy was tested on the constructed surface, confirming that the chosen supercell size and layers was sufficient for the convergence of H₂O adsorption energy. The adsorption energy was computed as follows:

$${E}_{ads} = {E}_{( slab + a dsorbate )} - ( {E}_{slab} + {E}_{a dsorbate} )$$

The zero-point energy (ZPE) and entropy correction to the adsorbates was also considered as known to those skilled in the art.

Examples of the above-described embodiments can include the following:
1. A method of producing at least one of ammonia or ammonium salt via geochemistry, comprising:
transporting an aqueous solution and a nitrogen source below a surface of the earth to facilitate a reaction to form at least one of ammonia or ammonium salt.
2. The method of example 1, wherein the aqueous solution is transported to a rock bed comprising ultramafic rock that is disposed below the surface of the earth.
3 The method of example 2, further comprising reacting the aqueous solution with the ultramafic rock to produce hydrogen gas (H₂).
4. The method of example 3, further comprising collecting the hydrogen gas in a reservoir.
5. The method of any of examples 2 to 4, wherein the nitrogen source comprises one or more of N₂, NO, N₂O, NO₂, NOₓ, or NO₃.
6. The method of example 5, further comprising reacting the hydrogen gas with the nitrogen source using geothermal energy to form the at least one of ammonia or the ammonium salt.
7. The method of any of examples 2 to 6, further comprising collecting the ammonium salt from the ultramafic rock, wherein the ammonium salt comprising one or more of Salammoniac (NH₄Cl) and ammonium bicarbonate (NH₄HCO₃).
8. The method of any of examples 1 to 7, further comprising transporting one or more secondary reactants below the surface of the earth to facilitate formation of the ammonium salt.
9. The method of example 4 or example 5, wherein the hydrogen gas reacts with the nitrogen source at a pressure approximately in a range of about 1 atm to about 400 atm.
10. The method of any of examples 5 to 9, wherein the hydrogen gas reacts with the nitrogen gas in a reaction vessel.
11. The method of any of examples 1 to 10, wherein transporting the aqueous solution and the nitrogen source through the surface of the earth comprises passing the aqueous solution and the nitrogen source through a plurality of boreholes disposed in the surface of the earth.
12. The method of any of examples 1 to 11, further comprising collecting the ammonia in a collection tank.
13. The method of any of examples 1 to 12, wherein the reaction occurs approximately in a range from about one foot below the surface of the earth to about five miles below the surface of the earth.
14. The method of any of examples 1 to 13, wherein the transporting comprises pumping or co-injecting the aqueous solution and the nitrogen source through a plurality of boreholes below the surface of the earth.
15. The method of any of examples 1 to 14, wherein the aqueous solution and the nitrogen source flow through a single borehole of a plurality of boreholes disposed in the surface of the earth.
16. The method of example 15, wherein the reaction occurs in a presence of one or more catalysts to produce ammonia.
17. The method of example 15 or example 16, wherein the ammonia is produced without forming hydrogen gas (H₂).
18. The method of any of examples 15 to 17, further comprising transporting the one or more catalysts to below the surface of the earth to increase one or more of the yield or rate of ammonia production.
19. The method of any of examples 15 to 18, further comprising transporting the one or more catalysts through the single borehole of the plurality of boreholes.
20. The method of any of examples 16 to 19, wherein the one or more catalysts comprise one or more of nickel, copper, cobalt, sodium, magnesium, calcium, titanium, chromium, iron, zinc, platinum, ruthenium, osmium, aluminum oxide, calcium oxide, molybdenum, ruthenium, alloys of different metals, or organic and metalorganic catalysts.
21. The method of any of examples 16 to 20, wherein the one or more catalysts is naturally occurring below the surface of the earth.
22. The method of any of examples 1 to 21, further comprising creating a droplet of the aqueous solution prior to transporting the aqueous solution below the surface of the earth, the droplets being created using an electrospray apparatus attached to the plurality of boreholes.
23. The method of any of examples 1 to 22, further comprising, using a controller, adjusting at least one of a flow rate of one or more of the aqueous solution or the nitrogen source transported below the surface of the earth or a composition of one or more of the aqueous solution or the nitrogen source.
24 The method of any of examples 1 to 23, wherein a conversion rate of ammonia from iron below the surface of the earth is in approximately a range from about 5% to about 80%.
25. The method of any of examples 1 to 24, wherein a yield of the ammonia ranges from about 10 g NH₃/t olivine to about 500 g NH₃/t olivine.
26. The method of example any of examples 1 to 25, further comprising withdrawing the ammonia from below the surface of the earth and collecting the ammonia in a collection tank.
27. A method of increasing a yield of ammonia production, comprising:
exposing an aqueous solution and a nitrogen source below a surface of the earth to an iron-containing rock bed in a presence of a catalyst to facilitate a reaction to form ammonia.
28. The method of example 27, further comprising co-injecting the aqueous solution and the nitrogen source below the surface of the earth.
29. The method of example 27 or example 28, wherein the catalyst is transported below the surface of the earth.
30. The method of any of examples 27 to 29, wherein the reaction forms ammonia without forming hydrogen gas (H₂).
31. The method of any of examples 27 to 30, wherein the catalyst is naturally occurring below the surface of the earth.
32. The method of any of examples 27 to 31, wherein the catalyst is naturally occurring within the iron-containing rock bed.
33. The method of any of examples 27 to 32, wherein the one or more catalysts further comprise nickel, copper, cobalt, sodium, magnesium, calcium, titanium, chromium, iron, zinc, platinum, ruthenium, osmium, aluminum oxide, calcium oxide, molybdenum, ruthenium, alloys of different metals, or organic and metalorganic catalysts.
34. The method of any of examples 27 to 33, wherein the reaction occurs at a temperature approximately in a range from about room temperature to about 500° C.
35. The method of any of examples 27 to 34, wherein the reaction occurs at a temperature approximately in a range from about room temperature to about 300° C.
36. The method of any of examples 27 to 35, wherein the reaction occurs at a pressure approximately in a range from about 1 atm (0.1 MPa) to about greater than 30 MPa.
37. A system for producing at least one of ammonia or ammonium salt via geochemistry, comprising:
one or more flow passages extending from a surface of the earth; and
an apparatus in fluid communication with the rock bed via the one or more flow passages, the apparatus being configured to deliver an aqueous solution and a nitrogen source proximate to a rock bed disposed below the surface of the earth to react with the rock bed to form a product.
38. The system of example 37, wherein the product is at least one of ammonium salt or hydrogen gas.
39. The system of example 37 or example 38, further comprising a reservoir configured to collect the product.
40. The system of example 39, wherein the reservoir is disposed below the surface of the earth.
41. The system of any of examples 37 to 40, further comprising a reaction tank in fluid communication with the one or more flow passages and configured to facilitate a reaction between the product and the nitrogen source to form a gas.
42. The system of example 41, wherein the reaction tank is disposed below the surface of the earth.
43. The system of example 41 or example 42, further comprising a collection well in fluid communication with the reaction tank and configured to collect the gas.
44. The system of any of examples 41 to 43, wherein the gas comprises ammonia.
45. The system of any of examples 37 to 44, further comprising a controller in communication with at least one of the one or more flow passages or the apparatus, the controller being configured to adjust at least one of a flow rate of one or more of the aqueous solution or the nitrogen source transported below the surface of the earth or a composition of one or more of the aqueous solution or the nitrogen source.

One skilled in the art will appreciate further features and advantages of the disclosures based on the provided for descriptions and embodiments. Accordingly, the inventions are not to be limited by what has been particularly shown and described. To the extent the present disclosure includes illustrations and descriptions that include prototypes, bench models, or schematic illustrations of set-ups, a person skilled in the art will recognize how to rely upon the present disclosure to integrate the techniques, systems, composition, designs, and methods provided for into a product and/or production method. All publications and references cited herein are expressly incorporated herein by reference in their entirety.

Some non-limiting claims that are supported by the contents of the present disclosure are provided below.

1. A method of producing at least one of ammonia or ammonium salt in situ in a subsurface region of earth, comprising:
transporting an aqueous solution and a nitrogen source below a surface of the earth to the subsurface region;
contacting an iron-containing rock in the subsurface region with the aqueous solution so that iron in the iron-containing rock is oxidized while reducing (i) water in the aqueous solution and (ii) the nitrogen source to form at least one of ammonia or ammonium salt under temperatures and pressures afforded by the subsurface region; and
collecting the at least one of ammonia or ammonium salt formed in the subsurface region.

2. The method of claim 1, wherein the at least one of ammonia or ammonium salt is formed without requiring formation of hydrogen gas as an intermediate.

3. The method of claim 1, wherein the aqueous solution reacts with the iron in the iron-containing rock to produce at least one of a hydrogen atom or hydrogen gas (H₂), and the at least one of a hydrogen atom or hydrogen gas reacts with the nitrogen source to form the at least one of ammonia or ammonium salt.

4. The method of claim 1, wherein the nitrogen source comprises one or more of N₂, NO, N₂O, NO₂, NOₓ, or NO₃⁻.

5. (canceled)

6. (canceled)

7. The method of claim 1, wherein the iron in the iron-containing rock is oxidized while reducing (i) water in the aqueous solution and (ii) the nitrogen source in a presence of one or more catalysts to form the at least one of ammonia or ammonium salt.

8. The method of claim 1, wherein transporting the aqueous solution and the nitrogen source to the subsurface region comprises passing the aqueous solution and the nitrogen source through a plurality of boreholes disposed in the surface of the earth.

9. The method of claim 1, wherein the subsurface region is approximately in a range from about one foot below the surface of the earth to about five miles below the surface of the earth.

10. The method of claim 1, wherein the aqueous solution and the nitrogen source flow through a single borehole of a plurality of boreholes disposed in the surface of the earth.

11. The method of claim 1, wherein the aqueous solution and the nitrogen source are separated while flowing through a single borehole of a plurality of boreholes disposed in the surface of the earth until the flow stream enters a reaction zone.

12. The method of claim 7, further comprising transporting the one or more catalysts through a borehole.

13. The method of claim 7, wherein the one or more catalysts comprise one or more of nickel, copper, cobalt, sodium, magnesium, calcium, titanium, chromium, iron, zinc, platinum, osmium, aluminum oxide, calcium oxide, molybdenum, ruthenium, one or more alloys of different metals, one or more organic catalysts, or one or more metalorganic catalysts.

14. The method of claim 7, wherein the one or more catalysts is naturally occurring below the surface of the earth.

15. (canceled)

16. (canceled)

17. A method of increasing a yield of at least one of ammonia production or ammonium salt production, comprising:
exposing an aqueous solution and a nitrogen source below a surface of the earth to an iron-containing rock bed in a presence of one or more catalysts to facilitate a reaction to form at least one of ammonia or ammonium salt under subsurface temperatures and pressures.

18. The method of claim 17, wherein the one or more catalysts is at least one of transported below the surface of the earth or naturally occurring below the surface of the earth.

19. (canceled)

20. The method of claim 17, wherein the reaction occurs at a pressure approximately in a range from about 1 atm to about 400 atm.

21. A system for producing at least one of ammonia or ammonium salt in situ in a subsurface region of earth, comprising:
one or more flow passages extending from a surface of the earth; and
an apparatus in fluid communication with an iron-containing rock in the subsurface region via the one or more flow passages,
wherein the apparatus is configured to deliver an aqueous solution and a nitrogen source proximate to the iron-containing rock disposed below the surface of the earth so that iron in the iron-containing rock is oxidized while reducing (i) water in the aqueous solution and (ii) the nitrogen source to form at least one of ammonia or ammonium salt under subsurface elevated temperature and pressure afforded by the subsurface region.

22. The system of claim 21,
wherein the aqueous solution reacts with the iron in the iron-containing rock to produce hydrogen gas, and
the system further comprises a reservoir configured to collect the hydrogen gas.

23. The system of claim 21, further comprising a reactor in fluid communication with the one or more flow passages and configured to facilitate a reaction between the hydrogen gas and the nitrogen source to form the at least one of ammonia or ammonium salt.

24. (canceled)

25. The system of claim 21, further comprising a controller in communication with at least one of the one or more flow passages or the apparatus, the controller being configured to adjust at least one of a flow rate of one or more of the aqueous solution or the nitrogen source transported below the surface of the earth or a composition of one or more of the aqueous solution or the nitrogen source

26. The method of claim 17, wherein the at least one of ammonia or ammonium salt is formed without requiring formation of hydrogen gas as an intermediate.
